(19) United States
(12) Patent Application Publication
(10) Pub. No.: US 2021/0230024 A1
(43) Pub. Date: Jul. 29, 2021

(54) CONTROLLED PRODUCED WATER DESALINATION FOR ENHANCED HYDROCARBON RECOVERY

(71) Applicant: Saltworks Technologies Inc., Richmond (CA)

(72) Inventors: Xiangchun Yin, Richmond (CA); Benjamin Sparrow, Richmond (CA); Malcolm Man, Richmond (CA)

(73) Assignee: Saltworks Technologies Inc., Richmond, BC (CA)

(21) Appl. No.: 16/341,776

(22) PCT Filed: Oct. 26, 2017
(86) PCT No.: PCT/CA2017/051278

§ 371 Date: Apr. 12, 2019

Related U.S. Application Data
(60) Provisional application No. 62/412,990, filed on Oct. 26, 2016.

(51) Int. Cl. C02F 1/469; C02F 1/40; B01D 61/46; B01D 61/54; B01D 69/02; B01D 71/40

(52) U.S. Cl. CPC C02F 1/4693; C02F 1/40; B01D 61/46; C02F 2103/10; B01D 69/02; B01D 71/40; B01D 61/54

(57) ABSTRACT

Processes, systems, and techniques for treating produced water drawn from a subterranean formation. The produced water is provided and contains dissolved solids and magnesium, calcium, and sodium ions. The produced water is desalinated using an electrically-driven membrane separation apparatus that includes alternating anion exchange membranes and cation exchange membranes defining opposing sides of alternating product and concentrate chambers. The desalinating involves flowing the produced water through the product chamber, flowing a second water through the concentrate chamber, and applying an electric potential across the cation and anion exchange membranes as the produced and second waters flow through the product and concentrate chambers, respectively. The product water is consequently produced and has a total dissolved solids content of between 300 mg/L and 8,000 mg/L, a total concentration of calcium ions and magnesium ions less than 100 mg/L, and a sodium adsorption ratio of 20 to 90.

### TECHNICAL FIELD

This present disclosure relates to processes, systems, and techniques for desalinating produced water for use in enhanced hydrocarbon (oil and/or gas) recovery. More particularly, the present disclosure relates to providing injection water, by desalinating produced water, for low salinity enhanced hydrocarbon recovery and/or chemically enhanced hydrocarbon recovery.

### BACKGROUND

In the oil and gas industry, water drawn from the subterranean formation is referred to as “produced water”. For every barrel of crude oil produced in certain cases, about three to ten barrels of produced water are generated. Produced water often contains elevated levels of dissolved solids, as represented by the produced water's total dissolved solid (TDS) content (e.g., above 2,000 mg/L), and of hydrocarbon constituents (e.g., free and dissolved oils, grease, organic acids, and BTEX compounds [benzene, toluene, ethylbenzene, and xylene]). Produced water generated by the oil and gas industry is generally disposed of by deep well injection, which is accompanied by environmental concerns.

### SUMMARY

According to a first aspect, there is provided a process for treating produced water drawn from a subterranean formation, the process comprising: (a) providing the produced water, wherein the produced water comprises dissolved solids, and magnesium, calcium, and sodium ions; (b) desalinating the produced water using an electrically-driven membrane separation apparatus, wherein the separation apparatus comprises alternating anion exchange membranes and cation exchange membranes defining opposing sides of alternating product and concentrate chambers, and wherein the desalinating comprises: (i) flowing the produced water through the product chamber; (ii) flowing a second water through the concentrate chamber; and (iii) applying an electric potential across the cation and anion exchange membranes as the produced and second waters flow through the product and concentrate chambers, respectively; and (c) producing, by desalinating the produced water, product water having a total dissolved solids content of between 300 mg/L and 8,000 mg/L, a total concentration of calcium ions and magnesium ions less than 100 mg/L, and a sodium adsorption ratio of 20 to 90.

The process may further comprise recovering hydrocarbons by injecting into the subterranean formation an injection water comprising the product water.

The process may further comprise prior to desalinating the produced water, pretreating the produced water to reduce a concentration of any one or more of suspended solids, greases, and oils therein, wherein the total dissolved solids content of the produced water before pretreatment and the total dissolved solids content of the produced water after pretreatment are within 20% of each other.

The electrically-driven membrane separation apparatus may comprise at least one of an electrodialysis apparatus, and electrodialysis reversal apparatus, and an electrodeionization apparatus.

At least one of the cation exchange membranes of the electrically-driven membrane separation apparatus may have permeability of at least 1.0 toward multivalent calcium and magnesium ions over monovalent sodium ions.

The permeability of the at least one of the cation exchange membranes toward multivalent calcium and magnesium ions over monovalent sodium ions may be between 1.05 and 10.0.

The produced water may comprise multivalent sulfate ions and monovalent chloride ions, and at least one of the anion exchange membranes of the electrically-driven membrane separation apparatus may have permeability of at least 1.5 toward multivalent sulfate ions over monovalent chloride ions.

At least one of the anion and cation exchange membranes may comprise crosslinked copolymers that comprise at least 20 wt % crosslinking monomers of total monomers for the crosslinked copolymers.

The crosslinked copolymers may comprise acrylic-base crosslinked copolymers, wherein monomers for the acrylic-base crosslinked copolymers comprise at least one of acrylate-base monomers, methacrylate-based monomers, acrylamide-based monomers, and methacrylamide-based monomers.

The process may further comprise dosing the second water with an acid such that a pH of the second water is between 3 and 8.

The produced water may comprises organic carbon and the product water may have a total organic carbon content of at least 10 mg/L.

The total organic carbon content of the produced water and the total organic carbon content of the product water may be within 20% of each other.

The organic carbon may comprise polymer additives.

The process may further comprise adding to the product water polymer additives comprising at least one of synthetic polyacrylamide, partially hydrolyzed polyacrylamide, xanthan, hydroxyl ethyl cellulose, guar gum, and sodium carboxymethyl cellulose.

The process may further comprise: (a) reversing a polarity of the electric potential from an initial polarity to a reverse polarity; and then (b) reversing the polarity of the electric potential from the reverse polarity to the initial polarity, wherein the chambers through which the produced and second waters flow remain unchanged immediately before, during, and immediately after the polarity is reversed.

The sodium adsorption ratio may be determined as

$$\frac{[ Na ]}{\sqrt{[ Ca ] + [ Mg ]}} ,$$

wherein [Na], [Ca], [Mg] are the concentrations in mol/m3 for Na⁺, Ca²⁺ and Mg²⁺ respectively in the product water.

According to another aspect, there is provided a system for treating produced water drawn from a subterranean formation, the system comprising: (a) an electrically-driven membrane separation apparatus for producing product water, the separation apparatus comprising alternating anion exchange membranes and cation exchange membranes defining opposing sides of alternating product and concentrate chambers; (b) valves, conduits, and pumps configured and positioned to control flow of the produced water and a second water through the product and concentrate chambers, respectively; (c) a voltage source electrically coupled to apply an electric potential across the exchange membranes; (d) at least one sensor configured and positioned to measure at least one of total dissolved solids content, and sodium, magnesium, and calcium ion concentration of the product water exiting the separation apparatus; and (e) at least one controller, communicatively coupled to the at least one sensor, the voltage source, and the valves, the at least one controller configured to: (i) flow the produced water and the second water through the product and concentrate chambers, respectively; (ii) apply an electric potential across the cation and anion exchange membranes as the produced and second waters flow through the product and concentrate chambers, respectively; and (iii) produce, by desalinating the produced water, product water having a total dissolved solids content of between 300 mg/L and 8,000 mg/L, a total concentration of calcium ions and magnesium ions less than 100 mg/L, and a sodium adsorption ratio of 20 to 90.

The system may further comprise a pretreatment unit positioned upstream of the separation apparatus and configured to pretreat the produced water to reduce a concentration of any one or more of suspended solids, greases, and oils therein prior to desalination using the separation apparatus, wherein the pretreatment unit is configured such that the total dissolved solids content of the produced water before pretreatment and the total dissolved solids content of the produced water after pretreatment are within 20% of each other.

The electrically-driven membrane separation apparatus may comprise at least one of an electrodialysis apparatus, and electrodialysis reversal apparatus, and an electrodeionization apparatus.

At least one of the cation exchange membranes of the electrically-driven membrane separation apparatus may have permeability of at least 1.0 toward multivalent calcium and magnesium ions over monovalent sodium ions.

The permeability of the at least one of the cation exchange membranes toward multivalent calcium and magnesium ions over monovalent sodium ions may be between 1.05 and 10.0.

The produced water may comprise multivalent sulfate ions and monovalent chloride ions, and at least one of the anion exchange membranes of the electrically-driven membrane separation apparatus may have permeability of at least 1.5 toward multivalent sulfate ions over monovalent chloride ions.

At least one of the anion and cation exchange membranes may comprise crosslinked copolymers that comprise at least 20 wt % crosslinking monomers of total monomers for the crosslinked copolymers.

The crosslinked copolymers may comprise acrylic-base crosslinked copolymers, wherein monomers for the acrylic-base crosslinked copolymers comprise at least one of acrylate-base monomers, methacrylate-based monomers, acrylamide-based monomers, and methacrylamide-based monomers.

The system may further comprise a pH control and acid dosing apparatus configured and positioned to dose the additional water with an acid such that a pH of the additional water is between 3 and 8.

The at least one controller may be further configured to: (a) reverse a polarity of the electric potential from an initial polarity to a reverse polarity; and then (b) reverse the polarity of the electric potential from the reverse polarity to the initial polarity, wherein the chambers through which the produced and second waters flow remain unchanged immediately before, during, and immediately after the polarity is reversed.

The sodium adsorption ratio may be determined as

$$\frac{[ Na ]}{\sqrt{[ Ca ] + [ Mg ]}} ,$$

wherein [Na], [Ca], [Mg] are the concentrations in mol/m3 for Na⁺, Ca²⁺ and Mg²⁺ respectively in the product water.

The at least one sensor may be further configured and positioned to measure total organic carbon content, and the at least one controller may be configured to produce the product water having a total organic carbon content of at least 10 mg/L.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a block diagram of a system that comprises an electrically-driven membrane separation apparatus to produce injection water having targeted ion compositions by desalinating a produced water, according to one example embodiment.

FIG. 2 illustrates an electrodialysis stack used as the electrically-driven membrane separation apparatus of FIG. 1.

FIG. 3 depicts curves of total dissolved solid (TDS) content, sodium adsorption ratio (SAR), and total concentration of calcium and magnesium ions of injection water produced using an electrodialysis stack of the type depicted in FIG. 2, in accordance with another example embodiment.

### DETAILED DESCRIPTION

Water-flooding has long been practiced for enhanced hydrocarbon recovery. During water-flooding, water with low salinity, either alone or combined with chemical additives, is injected into the subterranean formation. This injection displaces, or “sweeps”, hydrocarbons through the formation towards the hydrocarbon production wells. Many practitioners in the oil and gas industry believe that injecting into a formation injection water with low salinity lowers the rock's oil-wettability, which is beneficial for hydrocarbon sweeping. Certain polymer additives may also be added to the injection water used for hydrocarbon sweeping. When those polymer additives are used, salt ions in the flooding water (“polymer flooding solution”) screen the charges along polymer chains and induce polymer chains into a collapsed conformation in the polymer flooding solution, reducing the solution's viscosity. Lowering the salinity of the polymer flooding solution consequently induces polymer chains into an expanded conformation, increasing the solution's viscosity. This reduces the need to use expensive polymer viscosifier to achieve a high target viscosity, which is beneficial for enhanced hydrocarbon recovery.

Produced water generated during hydrocarbon (oil and/or gas) recovery contains significant levels (e.g., >400 mg/L) of organic carbon, as represented by the produced water's total organic carbon (TOC) content, and hydrocarbon constituents such as free and dissolved oils, organic acids, BTEX compounds (benzene, toluene, ethylbenzene, and xylene). A conventional water treatment process that relies on reverse osmosis (RO) or nanofiltration (NF) cannot be used to successfully treat the produced water unless that produced water first undergoes heavy pretreatment to remove those hydrocarbon constituents and organic carbon. One reason for this is that hydrocarbon constituents and organic carbon collect on reverse osmosis or nanofiltration membranes and under high pressure cause those membranes to lose their permeability and desalination capacity. In addition, nanofiltration and reverse osmosis focus on lowering the TDS content of the water being treated, as opposed to focusing on ionic composition. Most often, such a process includes several treatment blocks of nanofiltration and reverse osmosis assemblies connected in series and/or in parallel. Desalinated waters that have been treated using any one or more of those blocks are then blended or adjusted as necessary for use as injection water.

In addition to having low salinity, injection water to be used for enhanced hydrocarbon recovery may beneficially comprise targeted ion compositions. As used herein, a reference to ion “compositions” includes a reference to ion concentrations and/or ratios, such as the ratio of monovalent to multivalent cations. Injection water having a high concentration of multivalent cations (e.g., more than 200 mg/L in total) makes the rock oil-wettable, retarding enhanced hydrocarbon recovery. This may be because the multivalent cations, such as Ca²⁺ and Mg²⁺, act like bridges between the negatively charged oil droplets and the rock by forming organo-metallic complexes. Hydrocarbons therefore adsorb onto the oil-wettable rock surface and flow away from the formation is retarded. In addition, the viscosity of a polymer flooding solution is sensitive to multivalent cations far more than monovalent cations. Multivalent cations may cause polymer additive precipitation and degradation when exposed to an underground elevated temperature. The concentration of multivalent cations in the injection water, however, cannot be reduced below a minimum threshold: if the injection water contains only monovalent cations, the clay particles in the rock may swell or be stripped from the pore walls upon encountering the injection water, resulting in clay deflocculation and formation destabilization during water flooding. In addition, monovalent cations in injection water are not as efficient as multivalent cations in breaking the already formed organo-metallic complexes between the charged oil droplets and the rock. Thus, it is beneficial to create injection water by desalinating produced water with the goals of achieving targeted ion compositions. It is further beneficial to retain at least a portion of the organic carbon in the produced water during desalination so that the use of expensive polymer viscosifier in the injection water can be reduced.

Embodiments described herein are directed to an electrochemical membrane process for desalinating a produced water. The electrochemical membrane process desalinates the produced water in the presence of hydrocarbon constituents to produce an electrochemically desalinated product water with targeted ion compositions. The electrochemically desalinated product water may be used as injection water in an enhanced hydrocarbon recovery process.

In some embodiments, the electrochemical membrane process herein comprises using an electrically-driven membrane separation apparatus that desalinates a produced water having an elevated total dissolved solid (TDS) content, where “elevated” refers to a TDS content above 2,000 mg/L, and containing organic carbon as represented by TOC content. More particularly, the electrically-driven membrane separation apparatus desalinates a produced water under a controlled process to provide for injection water having targeted ion compositions, and more particularly targeted concentrations of monovalent and multivalent cations so as to achieve a targeted monovalent cation to multivalent cation ratio.

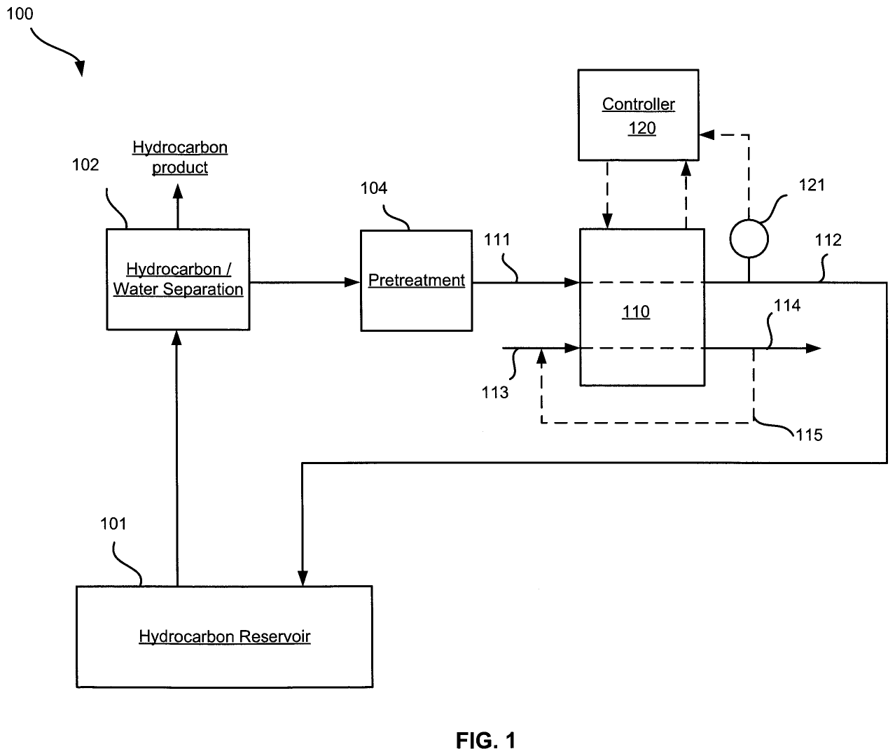

FIG. 1 illustrates a block diagram of a system 100 that comprises an electrically-driven membrane separation apparatus 110 that is used to generate injection water having targeted ion compositions by desalinating a produced water. The system 100 is used in conjunction with a hydrocarbon reservoir 101, from which a hydrocarbon-water mixture is recovered. The injection water is for use in enhanced hydrocarbon recovery. The system 100 comprises:
i) a hydrocarbon/water separation unit 102, fluidly coupled to the reservoir 101, which separates at least a portion of hydrocarbon from the hydrocarbon-water mixture to produce a hydrocarbon product and a produced water;
ii) a pretreatment unit 104 that is positioned upstream of the apparatus 110 and that pretreats the produced water to remove at least some of the suspended solids, greases, and oils therefrom to produce a pretreated produced water;
iii) the electrically-driven membrane separation apparatus 110, which desalinates the pretreated produced water and that consequently removes at least some salt ion species from it, thereby producing an electrochemically desalinated product water having a TDS content between 300 mg/L and 8,000 mg/L, a total concentration of calcium ions and magnesium ions less than 100 mg/L, a sodium adsorption ratio (SAR) value of 20 to 90, and a TOC content of at least 10 mg/L; and
iv) one or more sensors 121 and one or more controllers 120, as described in further detail below, to facilitate controlled desalination of the system 100.

The system 100 produces, by desalinating the produced water, the product water. The product water may be used as injection water for enhanced hydrocarbon recovery by being injected into the hydrocarbon reservoir 101.

In the depicted embodiment, the SAR value is determined according to Formula (I):

$$SAR = \frac{[ Na ]}{\sqrt{[ Ca ] + [ Mg ]}} \qquad \text{(I)}$$

wherein [Na], [Ca], [Mg] are the concentrations in mol/m³ for Na⁺, Ca²⁺ and Mg²⁺ respectively in the electrochemically desalinated product water.

In some embodiments, a process that uses the system 100 to produce the injection water comprises recovering hydrocarbon (oil and/or gas) from a production well drilled into a subterranean formation, in which case the reservoir 101 may comprise an onshore or offshore hydrocarbon reservoir.

In some embodiments, the process of using the system 100 comprises pumping the hydrocarbon-water mixture from the hydrocarbon production well to the separator 102 where the hydrocarbon product is separated from the water. After initial separation from the hydrocarbon product, the water may be further treated in a polishing separator (not depicted) to remove additional hydrocarbon and solids. The resulting water after hydrocarbon separation is in certain example embodiments referred to as the produced water.

In some embodiments, the process of using the system 100 comprises using the pretreatment unit 104 to facilitate the desalination of the produced water by the electrically-driven membrane separation apparatus 110. To economically pretreat the produced water and reduce footprint of the pretreatment unit 104, the pretreatment operations may simply comprise removing at least some of suspended solids, greases, and oils. The pretreatment may also include one or more of media filtration, microfiltration, ultrafiltration, coagulation, flocculation, gas flotation, clarification, and sedimentation. The pretreatment unit 104 may be configured such that the TDS content in the produced water before and after the pretreatment unit 104 is substantially unchanged. For example, the TDS content of the produced water before pretreatment and the total dissolved solids content of the produced water after pretreatment are within 10% of each other in one embodiment and 20% of each other in another embodiment.

In some embodiments, the pretreated produced water is directed via a conduit 111 from the pretreatment unit 104 to the electrically-driven membrane separation apparatus 110. A second water to receive the desalinated ion species from the pretreated produced water is fed via another conduit 113 to the electrically-driven membrane separation apparatus 110, and becomes concentrate saline water after passing through the electrically-driven membrane separation apparatus 110 by virtue of receiving ions from the pretreated produced water, as described in more detail below. The second water flowing in the other conduit 113 may comprise the pretreated produced water; additionally or alternatively, it may comprise seawater, particularly when the process is performed in conjunction with offshore hydrocarbon recovery.

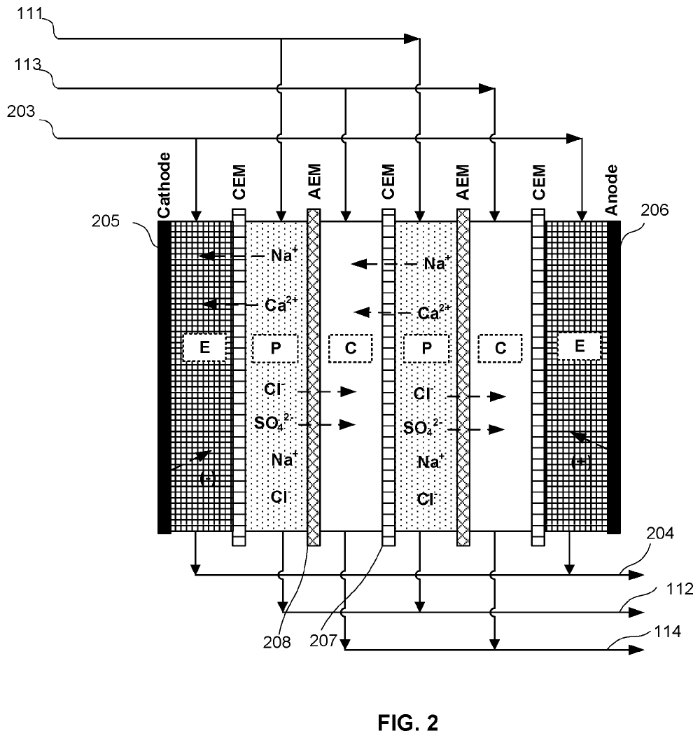

An embodiment of the structure and operation of the apparatus 110 is discussed in more detail with respect to FIG. 2 below. The embodiment of the apparatus 110 shown in FIG. 2 is an electrodialysis stack comprising at least one cation exchange membrane having a permeability of at least 1 toward multivalent calcium and magnesium ions over monovalent sodium ions. The apparatus 110 outputs an electrochemically desalinated product water via an output conduit 112 and a concentrate saline water via another output conduit 114. In some embodiments, the concentrate saline water is re-circulated via a recirculation conduit 115 to the input conduit 113 for further concentration and to reduce concentrate saline volume. The concentrate saline may be discharged, reused for other purposes, or further treated for reduced, and in certain embodiments zero liquid discharge.

The electrically-driven membrane separation apparatus 110 desalinates the produced water to produce injection water that is used in enhanced hydrocarbon recovery. The injection water comprises an electrochemically desalinated produced water having a TDS content between 300 mg/L and 8,000 mg/L, a total concentration of calcium ion and magnesium ion less than 100 mg/L, a SAR value from 20 to 90, and a TOC content of at least 10 mg/L.

In some embodiments, the pretreated produced water contains a significant TOC content, for example, above at least 10 mg/L TOC in certain embodiments, and above at least 100 mg/L TOC in other embodiments. The TOC is not significantly reduced by the electrically-driven membrane separation apparatus 110; for example, the TOC in the pretreated produced water and in the electrically-treated product water are within 20% of each other in some embodiments, and within 10% of each other in other example embodiments. The TOC may comprise polymer additives when the system 100 is used in conjunction with polymer flooding, and it may thus be beneficial to recover the TOC together with the reclaimed electrochemically desalinated product water for use as injection water.

In some embodiments, the apparatus 110 produces for injection water an electrochemically desalinated product water with a targeted monovalent cation to multivalent cation ratio. The characteristic value of monovalent cation to multivalent cation ratio in the electrochemically desalinated product water can be represented as an exchangeable sodium percentage or the SAR, as typically determined according to Formula (I).

In some embodiments, using the apparatus 110 produces for injection water an electrochemically desalinated product water with a total concentration of calcium ion and magnesium ion less than 100 mg/L and a SAR value from 20 to 90. Without being limited to a specific mechanism, the electrochemically desalinated product water may facilitate multicomponent ion exchange to break the interactions between the formation water and one or both of hydrocarbons and rock and to release the hydrocarbons from the clay surface comprising part of the formation.

In some embodiments, any one or more of the SAR value of the electrochemically desalinated product water, the total concentration of calcium and magnesium ions in the electrochemically desalinated product water, the TOC content, and the TDS content of the electrochemically desalinated product water serve as quality or suitability indications for its intended use as injection water in enhanced hydrocarbon recovery. In certain embodiments, the electrochemically desalinated product water has a TDS content between 300 mg/L and 8,000 mg/L, a total concentration of calcium ion and magnesium ion less than 100 mg/L, a SAR value from 20 to 90, and a TOC content of at least 10 mg/L.

The electrically-driven membrane separation apparatus 110 utilizes an electric field (not shown in FIG. 1) to create a motive force that drives one or more salt ion species to migrate from the produced water into the concentrate saline water under a controlled desalination process. In some embodiments, the apparatus 110 selectively desalinates from the produced water salt ions with a targeted composition (e.g., the apparatus 110 desalinates one or more ions of a certain type and/or to a certain concentration), which contrasts with other non-selective desalination processes. The final electrochemically desalinated product water from the electrically-driven membrane separation apparatus 110 has a TDS content between 300 mg/L and 8,000 mg/L, a total concentration of calcium ion and magnesium ion less than 100 mg/L, a SAR value from 20 to 90, and a TOC content of at least 10 mg/L. In certain embodiments, the apparatus 110 provides an electrochemically desalinated product water that may be used as injection water for enhanced hydrocarbon recovery without further addition or blending of preferred ion species, which contrasts with conventional RO and NF desalination processes where waters from various treatments must be adjusted by blending to meet the requirements of injection water.

In some embodiments, the electrically-driven membrane separation apparatus 110 may only remove from the produced water some of the salt ion species, but retain in the electrochemically desalinated product water non-ionic species and weakly ionized organic molecules such as hydrocarbons and TOC. The TOC content in the produced water before and after desalination by the electrically-driven membrane separation apparatus 110 is substantially unchanged; for example, the TOC content in the pretreated produced water and in the electrically-treated product water are within 20% of each other in some embodiments, and within 10% of each other in other example embodiments. The TOC may comprise polymer additives during polymer flooding and it may be beneficial to recover the polymer additives together with the reclaimed electrochemically desalinated product water for injection water for use in enhanced hydrocarbon recovery. In some embodiments, the electrically-driven membrane separation apparatus 110 and its operation are designed for retaining the property of the polymer additives during the desalination, for example, the produced water is delivered to the electrically-driven membrane separation apparatus 110 using low hydraulic shear and low shear pump to prevent the degradation of polymer additives by hydraulic shearing force.

In some embodiments, the electrochemically desalinated product water has a TDS content between 300 mg/L and 8,000 mg/L, a total concentration of calcium ion and magnesium ion less than 100 mg/L, a SAR value from 20 and 90 and a TOC content of at least 10 mg/L may be formulated for use as injection water with additional polymer additives such as synthetic polyacrylamide, partially hydrolyzed polyacrylamide, xanthan, hydroxyl ethyl cellulose, guar gum and sodium carboxymethyl cellulose. The dissolution of polymer additives in the electrochemically desalinated product water may take at least 24 hours to allow full hydration of those polymer additives. The polymer chains dissolved in the electrochemically desalinated product water are in an expanded conformation and the polymer flooding solution can reach the target viscosity for enhanced hydrocarbon recovery with a total polymer concentration of less than 1.0 g/L.

In some embodiments, and as discussed above in respect of FIG. 1, the electrically-driven membrane separation apparatus 110 is operated under the control of one or more controllers 120 that are communicatively coupled to one or more sensors 121 for monitoring desalination parameters of the electrochemically desalinated product water. The one or more sensors 121 are configured and positioned to provide indications of water quality and of operational parameters for the electrically-driven membrane separation apparatus 110; for example, the one or more sensors 121 may report to the one or more controllers 120 any one or more of TDS content, TOC content, and sodium, magnesium, and calcium ion concentration of the product water exiting the separation apparatus, either directly or indirectly as represented by the SAR. The one or more sensors 121 provide feedback to the one or more controllers 120 to regulate one or more parameters of the operation of the electrically-driven membrane separation apparatus 110 and to adjust at least one operating parameter of separation apparatus typically to at least one desired condition and to provide desalinated product water having the one or more desired characteristics. For example, the one or more controllers 120 can adjust the current, potential, or both, of the applied electric field for the electrically-driven membrane separation apparatus 110 to control the ion removal and ion concentrations in the desalinated product water. Other parameters that may be adjusted include, for example, pressure, temperature, pH, flow rate, and ionic current density through the apparatus 110; the one or more sensors 121 may accordingly measure any one or more of those parameters. The one or more controllers 120 may operate the apparatus 110 in a continuous manner or in a batch manner by controlling suitable valves, conduits, and pumps (not shown). The produced water may be recirculated through the apparatus 110 as many times as desired so as to achieve the desired targeted ion composition. The one or more controllers 120 may comprise any one or more of integrated circuits (IC), including being implemented by a monolithic integrated circuit (MIC), an application specific integrated circuit (ASIC), a field programmable gate array (FPGA), and a programmable logic controller (PLC).

In some embodiments, the controlled desalination process relies on the electrically-driven membrane separation apparatus 110 comprising at least one cation exchange membrane having a permeability toward multivalent calcium and magnesium ions over monovalent sodium ions of at least 1.0, preferably between 1.05 and 10.0. The permeability of a membrane is defined as the ratio between the transport rate of multivalent calcium and magnesium ions and that of monovalent sodium ions through the membrane, and allows the apparatus 110 to desalinate the produced water in a controlled way that targets removal of certain ion species while retaining other species. Example electrically-driven membrane separation apparatuses 110 comprise electrodialysis (ED) and electrodialysis reversal (EDR) apparatuses, and electrodeionization (EDI) apparatuses as well as a combination of two or more of these electrically-driven membrane separation apparatuses connected in series and/or parallel. An ED, EDR, or EDI apparatus may comprise alternating anion exchange membranes and cation exchange membranes, among which is at least one cation exchange membrane having permeability toward multivalent calcium and magnesium ions over monovalent sodium ions of at least 1.0, preferably between 1.05 and 10.0. An ED, EDR, or EDI apparatus may be a stack, spiral, cylindrical, or any other suitable shape.

The permeability P_{Na}^{M} of a cation exchange membrane is defined as the ratio between the specific transport amount of multivalent calcium and magnesium ions and that of monovalent sodium ions through the membrane. The permeability P_{Na}^{M} of Ca⁺ and Mg²⁺ over Na²⁺ is determined according to the Formula (II):

P_{Na}^{M}=[2(ΔC_{Ca}+ΔC_{Mg})/(C_{Ca}+C_{Mg})]/(ΔC_{Na}/C_{Na}) (II)

wherein C_{Ca}, C_{Mg}, and C_{Na} are the initial molarities of Ca²⁺, Mg²⁺, and Na⁺ in the solution to be desalinated, and ΔC_{Ca}, ΔC_{Mg}, ΔC_{Na} are the molarity changes of Ca²⁺, Mg²⁺, and Na⁺ respectively in the solution to be desalinated before and after desalination within a predetermined desalination percentage (for example, around 20-50% of TDS content is desalinated for a solution comprising 0.1 mol/L NaCl, 0.02 mol/L MgCl₂, and 0.02 mol/L CaCl₂). The permeability P_{Na}^{M} of a cation exchange membrane toward multivalent Ca²⁺ and Mg²⁺ over monovalent Na⁺ may be determined according to the following process: a four-compartment electrodialysis cell is set up by disposing in order, from one side of the cell to the other: a silver-silver chloride electrode, an anode compartment, a first anion exchange membrane, a dilute compartment, a testing selective cation exchange membrane, a concentrate compartment, a second anion exchange membrane, a cathode compartment, and a silver-silver chloride electrode. The electrodialysis cell has an effective current-carrying membrane area of 10.0 cm². Both the anode compartment and cathode compartment are fed with 0.2 mol/L NaCl solution; the dilute compartment is fed with 4 liters of a solution comprising 0.1 mol/L NaCl, 0.02 mol/L MgCl₂, and 0.02 mol/L CaCl₂; and the concentrate compartment is fed with 4 liters of 0.1 mol/L NaCl solution. Electrodialysis evaluation is performed at 20° C. and a current density of 2 A/dm² for 1 h. The concentrations of Ca²⁺, Mg²⁺, and Na⁺ in the solution flowing in the dilute chamber are measured before and after the electrodialysis evaluation. The permeability P_{Na}^{M} of Ca²⁺ and Mg²⁺ over Na⁺ is determined according to Formula (II), wherein C_{Ca}, C_{Mg}, and C_{Na} are the initial molarities of Ca²⁺ (0.02 mol/L), Mg²⁺ (0.02 mol/L), and Na⁺ (0.1 mol/L) in the solution fed to the dilute chamber before electrodialysis, and ΔC_{Ca}, ΔC_{Mg}, ΔC_{Na} are the molarity changes of Ca²⁺, Mg²⁺, and Na⁺ respectively in the solution flowing in the dilute chamber before and after electrodialysis. Suitable cation exchange membranes comprise Ionflux™ CEM with P_{Na}^{M}=3.0 from Saltworks Technologies Inc.

In some embodiments, the electrically-driven membrane separation apparatus 110 may use an anion exchange membrane having a permeability P_{Cl}^{SO4} toward multivalent sulfate ions over monovalent chloride ions of at least 1.5, promoting removal of multivalent sulfate ions, wherein the permeability P_{Cl}^{SO4} of sulfate ion over chloride ion is determined according to the Formula (III):

P_{Cl}^{SO4}=2(ΔC_{SO4}/C_{SO4})/(ΔC_{Cl}/C_{Cl}) (III)

wherein C_{SO4} and C_{Cl} are the initial molarities of SO₄²⁻ and Cl⁻ in the solution to be desalinated, and ΔC_{SO4} and ΔC_{Cl} are the molarity changes of SO₄²⁻ and Cl⁻ respectively in the solution to be desalinated before and after desalination within a predetermined desalination percentage (for example, around 20-50% of TDS content is desalinated for a solution comprising 0.1 mol/L NaCl, and 0.02 mol/L Na₂SO₄). The Pr of an anion exchange membrane toward multivalent SO₄²⁻ over monovalent Cl⁻ may be determined according to the following process: a four-compartment electrodialysis cell is set up by disposing, from one side of the cell to the other: a silver-silver chloride electrode, a cathode compartment, a first cation exchange membrane, a dilute compartment, a testing selective anion exchange membrane, a concentrate compartment, a second cation exchange membrane, an anode compartment, a silver-silver chloride electrode. The electrodialysis cell has an effective current-carrying membrane area of 10.0 cm². Both the anode compartment and cathode compartment are fed with 0.2 mol/L NaCl solution, the dilute compartment is fed with 4 liters of a solution comprising 0.1 mol/L NaCl, and 0.02 mol/L Na₂SO₄, and the concentrate compartment is fed with 4 liter of 0.1 mol/L NaCl solution. Electrodialysis evaluation is performed at 20° C. and a current density of 2 A/dm² for 1 h. The concentrations of SO₄²⁻ and Cl⁻ in the solution flowing in the dilute chamber are measured before and after the electrodialysis evaluation. The permeability P_{Cl}^{SO4} of sulfate ion over chloride ion is determined according to Formula (III), wherein C_{SO4} and C_{Cl} are the initial molarities of SO₄²⁻ (0.02 mol/L) and Cl⁻ (0.1 mol/L) in the solution fed to the dilute chamber before electrodialysis, and ΔC_{SO4} and ΔC_{Cl} are the molarity changes of SO₄²⁻ and Cl⁻ respectively in the solution flowing in the dilute chamber before and after electrodialysis. Suitable anion exchange membranes comprise Ionflux™ AEM with P_{Cl}^{SO4}=1.8 from Saltworks Technologies Inc.

In some embodiments, the electrically-driven membrane separation apparatus 110 comprises anion exchange membranes and cation exchange membranes made from crosslinked copolymers that are tolerable to hydrocarbon constituents in the produced water. In one example, the crosslinking monomer in the anion exchange membranes and cation exchanges membranes comprise at least 20 wt %, preferably at least 30 wt %, more preferably at least 40 wt % of the total monomers in those membranes.

In some embodiments, the electrically-driven membrane separation apparatus 110 comprises anion exchange membranes and cation exchange membranes made from acrylic-base crosslinked copolymers, wherein the monomers for the acrylic-base crosslinked copolymers are selected from at least one of acrylate-base monomers, methacrylate-based monomers, acrylamide-based monomers, and methacrylamide-based monomers. Acrylic-base crosslinked copolymers are more compatible with the produced water than the styrene-based crosslinked copolymers. In one example embodiment, during making of a suitable cation exchange membrane for the electrically-driven membrane separation apparatus 110, the monomer of acrylamidomethylpropane sulfonic acid (150 g) and a crosslinking monomer of ethylene glycol dimethacrylate (150 g) are mixed in the presence of N,N-dimethylacrylamide (120 g) and tributylamine (30 g) as a solution. A photoinitiator (9.2 g) Irgacure 2959 is added and dissolved in the solution. The solution is subsequently coated onto a woven fabric and cured under UV irradiation to make the cation exchange membrane.

In some embodiments, the electrically-driven membrane separation apparatus 110 comprises anion exchange membranes and/or cation exchange membranes having anti-fouling properties by virtue of their compositions. Suitable membranes include the surfaces of cation and anion exchange membranes modified by polydopamine polymers or by polyethylene glycol polymers.

In some embodiments, the controlled desalination process relies on the one or more controllers 120 to mitigate the scaling and fouling potentials from species such as CaSO₄, silica, organic acid, oils, and greases in the produced water, for example, by switching the electrodialysis operation in between the forward polarity operating mode and the reverse polarity operating mode periodically or at predetermined times.

Turning now to FIG. 2, there is illustrated one embodiment of an electrically-driven membrane separation apparatus 110 used in FIG. 1 in the form of an electrodialysis stack. The electrodialysis stack comprises a first electrode 205 at one end of the stack and a second electrode 206 at an opposite end of the stack, and a plurality of ion exchange membranes disposed between the first and second electrodes 205, 206. The first and second electrodes 205, 206 are electrically coupled to a voltage source such as a direct current power supply (not depicted in FIG. 2). When the electrodialysis stack is in a forward polarity operating mode as shown in FIG. 2, the first electrode 205 acts as a cathode and the second electrode 206 acts as an anode. Alternatively, the polarity of the first and second electrodes 205, 206 may be reversed when the electrodialysis stack is in a reversed polarity operating mode (not shown).

Two types of ion exchange membranes separate chambers of the electrodialysis stack: cation exchange membranes 207 (each a “CEM 207”) and anion exchange membranes 208 (each an “AEM 208”). The CEMs 207 are ion exchange membranes permeable to cations with a permeability P_{Na}^{M} toward Ca²⁺ and Mg²⁺ over Na⁺ of at least 1.0, preferably between 1.05 and 10.0 and substantially impermeable to and, in some embodiments and depending on operating conditions, entirely impermeable to anions. The AEMs 208 are ion exchange membranes permeable to anions and substantially impermeable to, and in some embodiments and depending on operating conditions entirely impermeable to, cations. In some applications, the AEMs 208 may be standard anion exchange membranes permeable to both monovalent and multivalent anions without permeability preference. In alternative applications, the AEMs 208 may be anion exchange membrane having a permeability Pr toward multivalent sulfate ions over monovalent chloride ions of at least 1.5. An example of a suitable CEM 207 is the Ionflux™ CEM with P_{Na}^{M}=3.0 from Saltworks Technologies Inc. An example of a suitable AEM 208 is the Ionflux™ AEM with P_{Cl}^{SO4}=1.8 from Saltworks Technologies Inc.

As illustrated in FIG. 2, the electrodialysis stack comprises a first and a second electrolyte chamber, each labeled with an “E” in FIG. 2 (hereinafter interchangeably referred to as “E-chambers”), bounded by one of the electrodes 205, 206 and a cation exchange membrane 207. An electrolyte solution is fed to and exits from the E-chambers through a pair of conduits 203, 204. Example electrolytes may comprise sulfuric acid, aqueous sodium sulfate, and aqueous potassium nitrate.

For the stack of FIG. 2, the alternating CEMs 207 and AEMs 208 form by defining opposing sides of alternating product chambers, each labeled with a “P” in FIG. 2 (hereinafter interchangeably referred to as “P-chambers”), and concentrate chambers, each labeled with a “C” in FIG. 2 (hereinafter interchangeably referred to as “C-chambers”), situated between the first and second electrodes 205, 206. During a controlled desalination operation, while an electrical potential is applied across the electrodialysis stack, the pretreated produced water is introduced to the electrodialysis stack and flows through its product chambers through a conduit 111, and a second water to receive and carry away the desalinated ion species is fed via another conduit 113 to the electrodialysis stack and flows through its concentrate chambers. As a result of desalination, some of the ion species (for example, Na⁺, Cl⁻, Ca²⁺ and SO₄²⁻) in the pretreated produced water flowing through the P-chambers are removed and carried away by the solution flowing through the C-chambers. With the usage of selective cation exchange membranes having a permeability P_{Na}^{M} toward multivalent calcium and magnesium ions over monovalent sodium ions of at least 1.0, preferably between 1.05 and 10.0, the final fluid output from the P-chambers via conduit 112 becomes an electrochemically desalinated product water with targeted ion compositions, such as a TDS between 300 mg/L and 8,000 mg/L, a total concentration of calcium ion and magnesium ion less than 100 mg/L, a SAR value from 20 to 90 and a TOC content at least 10.0 mg/L, and the solution output from the C-chambers via conduit 114 becomes a concentrate saline water. The concentration and type of targeted ion compositions may be determined by adjusting the permeability of the membranes toward those that are less preferred in the P-chambers, and/or by adjusting stack run-time.

In some embodiments, the produced water treated by the stack comprises scaling species (for example, CaSO₄ and silica) and/or fouling species (for example, ionic surfactants, oil or grease) that may scale and/or foul the membranes 207, 208. The scaling or fouling to the stack's membranes can be mitigated by switching the stack's operation between the forward polarity operating mode and the reverse polarity operating mode periodically or at predetermined times.

In some embodiments, the switching of electrodialysis operation in between the forward polarity operating mode and the reverse polarity operating mode comprises reversing the polarity of the potential applied to the electrodialysis stack and also a hydraulic shift comprising swapping the fluids flowing in the product chamber and the concentrate chamber. The changes of the direction of ion transfer through the membranes and the fluid swapping help “wash” the scaling or fouling components from the membrane surfaces. The polarity reversal and hydraulic swap may occur simultaneously in some embodiments; in other embodiments, while the stack may operate in a reverse polarity with fluids in their swapped changes, the actual reversal and hydraulic swap do not occur simultaneously.

In some embodiments, the switching of electrodialysis operation in between the forward polarity operating mode and the reverse polarity operating mode comprises only reversing the polarity of the potential applied to the electrodialysis stack without swapping the fluids flowing in the product chamber and the concentrate chamber. For example, after the electrodialysis stack runs with the forward electric current to desalinate the produced water for a set period at an initial polarity (e.g., 10 mins), the polarity of the electric current applied to the electrodialysis stack is reversed for a short time (e.g., 10 seconds) to a reverse polarity and is then reversed back to the initial polarity so that the stack runs in the forward mode for another set period (e.g., 10 mins), and so on. During the polarity reversal, the fluids flowing through the product chambers and the concentrate chambers are not swapped; consequently, the chambers of the stack through which the produced and second waters flow remain unchanged immediately before, during, and after the polarity is reversed. Reversing polarity across the stack without swapping the fluids flowing in the product chamber and the concentrate chamber may be beneficial for economical desalination by not contaminating the desalinated product water with the concentrate saline water, which occurs during a fluid swap, especially when the salt concentration in the concentrate saline solution is greater than 20 times that of the desalinated product water.

In some embodiments, the scaling or fouling to the stack's membranes 207, 208 can be cleaned in place with acidic solutions, including nitric, hydrochloric or other mineral acids to remove any carbonate precipitates and organic foulants. Basic wash solutions may also be employed, such as after an acid wash, to remove organic foulants. The cleaning-in-place (CIP) procedure may be performed using a wash solution at a temperature higher than that of the concentrate saline water and produced water.

In some embodiments, the CIP wash solution is formulated using the pretreated produced water: a cleaning agent is added to the produced water after it has been pretreated to form a CIP solution, which contrasts with a conventional CIP process, which uses high quality water (e.g., water either from the city utility or from RO permeate).

In some embodiments, to mitigate the scaling or fouling from carbonate and or organic acid species from the produced water, a pH control and acid dosing apparatus (not depicted in FIG. 2) may be in fluid connection with the fluid of concentrate saline solution to control its pH within a certain pH range, for example, from pH 3 to 8, preferably from pH 4 to pH 7, and more preferably from pH 5 to pH 6.5. Suitable acid includes nitric, hydrochloric or other mineral acids excluding sulfuric acid. Sulfuric acid may introduce sulfate ion in the desalination process and is not desirable for injection water. Dosing acid during the electrodialysis into the fluid of the concentrate saline solution instead of the fluid of the produced water is beneficial for economical desalination in terms of acid consumption and the desalination efficiency.

In some embodiments (not depicted in FIG. 2), it may be beneficial for cost efficiency purposes to use a control subsystem to control and/or regulate operations of the electrodialysis stack. As depicted in FIG. 1, in one example embodiment, the control subsystem comprises one or more controllers 120 that are communicatively coupled to various sensors 121 and valves (not depicted). The switching operation between the forward mode and the reverse mode may be controlled by the one or more controllers 120. The one or more controllers 120 control the set points at which the switching takes place. This may be triggered by pre-programmed conditions based on one or more of desalination period, the stack's electrical resistance, and the TDS content of the desalinated product water; the sensors 121 accordingly may measure any one or more of current desalination time, the stack's electrical resistance, and the TDS content of the desalinated product water. The flow directions of the desalinated produced water and the concentrate saline water may also be controlled by the control subsystem to prevent the contamination of the desalinated product water by the concentrate saline solution and/or vice versa. For example, mixing of these two fluids exiting the electrodialysis stack are confined to less than 10% of the volume of the concentrated salt water during the switching operation.

In the foregoing example embodiments, the product water that is used as injection water has a TDS content between 300 mg/L and 8,000 mg/L, a total concentration of calcium ion and magnesium ion less than 100 mg/L, a SAR value from 20 to 90, and a TOC content of at least 10 mg/L. However, in different embodiments, the product water may differ in any one or more of these parameters; for example, the product water may have a TDS content outside of 300 mg/L and 8,000 mg/L, a total concentration of calcium ion and magnesium ion more than 100 mg/L, a SAR value outside of 20 to 90, a TOC content of less than 10 mg/L, or any combination thereof. As another example, the product water may have a TDS content between 300 mg/L and 8,000 mg/L, a total concentration of calcium ion and magnesium ion less than 100 mg/L, and a SAR value from 20 to 90, and any TOC content.

Certain embodiments are further illustrated in the following examples. It is however to be understood that these examples are for illustrative purposes only, and are not to be used to limit the scope of the present disclosure in any manner.

### EXAMPLES

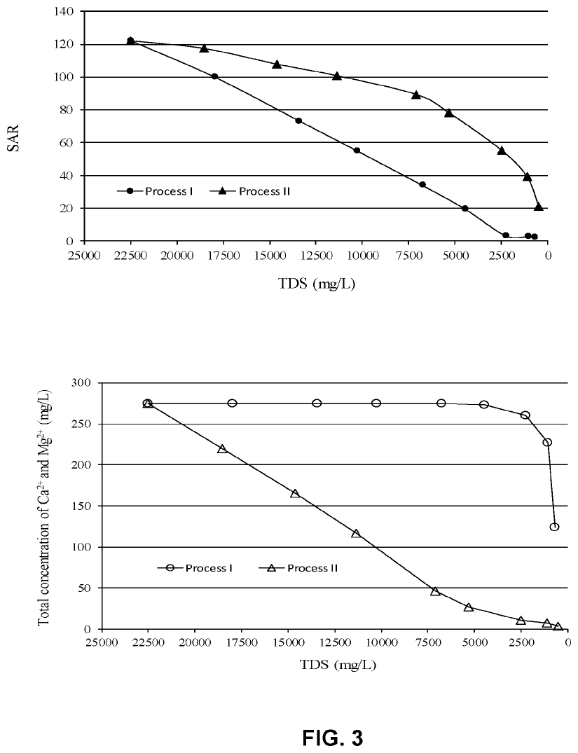

In one example, the produced water is first pretreated by microfiltration and then is treated by an ED apparatus comprising a cation exchange membrane having permeability toward monovalent cations over multivalent cations (Process I) as a control, or by an ED apparatus comprising a cation exchange membrane having permeability in accordance with the embodiments described above (Process II). Both ED apparatuses comprise 5 repeating cells with the configuration of each repeating cell, from one electrode of the apparatus to the other, of an anion exchange membrane, product chamber, cation exchange membrane, and concentrate chamber. Ionflux™ AEMs from Saltworks Technologies Inc. are used as anion exchange membranes for both ED apparatuses. The ED apparatus of Process I uses as cation exchange membranes Ionflux™ monovalent selective mCEMs with P_{Na}^{Ca}=0.2 from Saltworks Technologies Inc., and the ED apparatus of Process II uses as cation exchange membranes Ionflux™ CEMs with P_{Na}^{Ca}=3.0 from Saltworks Technologies Inc. FIG. 3 shows the results of TDS, total concentration of calcium and magnesium ions, and SAR values at various desalination stages of a produced water from Processes I and II.

Table 1 shows example desalination results following performance of Processes I and II such that the desalinated product water has a TDS of approximately 1,000 mg/L. After microfiltration pretreatment, the pretreated produced water has a TDS of 22,510 mg/L, a total concentration of calcium and magnesium ions of 275 mg/L, and a SAR value of 122, which suggest that the pretreated produced water is unsuitable for use as an injection water for enhanced hydrocarbon recovery. The electrochemically desalinated produced water from Process I has the targeted TDS of 1,140 mg/L but a total concentration of calcium and magnesium ions of 227 mg/L and a SAR value of 2.7; both the total concentration of calcium and magnesium ions and SAR value suggest this desalinated produced water is unsuitable for use as an injection water for enhanced hydrocarbon recovery. In contrast, the electrochemically treated product water from Process II in accordance with the embodiments described herein has a targeted TDS of 1,114 mg/L, a total concentration of calcium and magnesium ions of 7.7 mg/L and a SAR value of 38.6, suggesting that the electrochemically treated product water is suitable for use as an injection fluid for enhanced hydrocarbon recovery.

TABLE 1
Electrochemical desalinations for produced
water from Processes I and II

| | Produced | Treated from | Treated from |
|---|---|---|---|
| | water feed | Process I | Process II |
| Total Dissolved Solids (mg/L) | 22510 | 1140 | 1114 |
| Total Organic Carbon (mg/L) | 85 | 75 | 68 |
| Aluminum (mg/L) | 1.0 | 0.9 | 0.01 |
| Ammonia-N (mg/L) | 52 | 0.8 | 1.5 |
| Barium (mg/L) | 4.34 | 3 | 0.032 |
| Bicarbonate (as CaCO3) (mg/L) | 869 | 18.7 | 19.8 |
| Boron (mg/L) | 35.9 | 25.2 | 21.4 |
| Bromide (mg/L) | 60 | 1.6 | 1.4 |
| Calcium (mg/L) | 182 | 152 | 5.1 |
| Chloride (mg/L) | 13800 | 651 | 624.5 |
| Iron (mg/L) | 5.5 | 5.3 | 0.01 |
| Lithium (mg/L) | 1.81 | 0.02 | 0.03 |
| Magnesium (mg/L) | 93.3 | 75.2 | 2.64 |
| Potassium (mg/L) | 78 | 0.3 | 2.2 |
| Silica (Reactive) (mg/L) | 24.1 | 22.8 | 22.5 |
| Sodium (mg/L) | 8150 | 167 | 433 |
| Strontium (mg/L) | 25.5 | 16.4 | 0.12 |
| SAR value | 122 | 2.7 | 38.6 |

The embodiments have been described above with reference to flow, sequence, and block diagrams of processes, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, and “coupling” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. The term “and/or” used in conjunction with a list of options means “one or more of” that list of options; for example, a reference to “A, B, and/or C” means any one or more of A, B, and C. All ranges used herein are inclusive of the end values of that range unless the context requires otherwise.

It is contemplated that any part of any aspect or embodiment discussed in this specification can be implemented or combined with any part of any other aspect or embodiment discussed in this specification.

One or more example embodiments have been described by way of illustration only. This description is presented for purposes of illustration and description, but is not intended to be exhaustive or limited to the form disclosed. It will be apparent to persons skilled in the art that a number of variations and modifications can be made without departing from the scope of the claims.

1. A process for treating produced water drawn from a subterranean formation, the process comprising:
(a) providing the produced water, wherein the produced water comprises dissolved solids, and magnesium, calcium, and sodium ions;
(b) desalinating the produced water using an electrically-driven membrane separation apparatus, wherein the separation apparatus comprises alternating anion exchange membranes and cation exchange membranes defining opposing sides of alternating product and concentrate chambers, wherein the permeability of at least one of the cation exchange membranes toward multivalent calcium and magnesium ions over monovalent sodium ions is between 1.05 and 10.0, and wherein the desalinating comprises:
(i) flowing the produced water through the product chamber;
(ii) flowing a second water through the concentrate chamber; and
(iii) applying an electric potential across the cation and anion exchange membranes as the produced and second waters flow through the product and concentrate chambers, respectively; and
(c) producing, by desalinating the produced water, product water having a total dissolved solids content of between 300 mg/L and 8,000 mg/L, a total concentration of calcium ions and magnesium ions less than 100 mg/L, and a sodium adsorption ratio of 20 to 90.

2. The process of claim 1, further comprising recovering hydrocarbons by injecting into the subterranean formation an injection water comprising the product water.

3. The process of claim 1, further comprising prior to desalinating the produced water, pretreating the produced water to reduce a concentration of any one or more of suspended solids, greases, and oils therein, wherein the total dissolved solids content of the produced water before pretreatment and the total dissolved solids content of the produced water after pretreatment are within 20% of each other.

4. The process of claim 1, wherein the electrically-driven membrane separation apparatus comprises at least one of an electrodialysis apparatus, an electrodialysis reversal apparatus, and an electrodeionization apparatus.

5. The process of claim 1, wherein at least one of the anion exchange membranes of the electrically-driven membrane separation apparatus has permeability of at least 1.5 toward multivalent sulfate ions over monovalent chloride ions.

6. The process of claim 1, wherein at least one of the anion and cation exchange membranes comprises crosslinked copolymers that comprise at least 20 wt % crosslinking monomers of total monomers for the crosslinked copolymers.

7. The process of claim 6, wherein the crosslinked copolymers comprise acrylic-base crosslinked copolymers, wherein monomers for the acrylic-base crosslinked copolymers comprise at least one of acrylate-base monomers, methacrylate-based monomers, acrylamide-based monomers, and methacrylamide-based monomers.

8. The process of claim 1, further comprising dosing the second water with an acid such that a pH of the second water is between 3 and 8.

9. (canceled)

10. (canceled)

11. (canceled)

12. The process of claim 1, further comprising adding to the product water polymer additives comprising at least one of synthetic polyacrylamide, partially hydrolyzed polyacrylamide, xanthan, hydroxyl ethyl cellulose, guar gum, and sodium carboxymethyl cellulose.

13. The process of claim 1, further comprising:
(a) reversing a polarity of the electric potential from an initial polarity to a reverse polarity; and then
(b) reversing the polarity of the electric potential from the reverse polarity to the initial polarity,
wherein the chambers through which the produced and second waters flow remain unchanged immediately before, during, and immediately after the polarity is reversed.

14. The process of claim 1, wherein the sodium adsorption ratio is determined as
$$\frac{[ Na ]}{\sqrt{[ Ca ] + [ Mg ]}} ,$$
wherein [Na], [Ca], [Mg] are the concentrations in mol/m³ for Na⁺, Ca²⁺ and Mg²⁺ respectively in the product water.

15. A system for treating produced water drawn from a subterranean formation, the system comprising:
(a) an electrically-driven membrane separation apparatus for producing product water, the separation apparatus comprising alternating anion exchange membranes and cation exchange membranes defining opposing sides of alternating product and concentrate chambers, wherein the permeability of at least one of the cation exchange membranes toward multivalent calcium and magnesium ions over monovalent sodium ions is between 1.05 and 10.0;
(b) valves, conduits, and pumps configured and positioned to control flow of the produced water and a second water through the product and concentrate chambers, respectively;
(c) a voltage source electrically coupled to apply an electric potential across the exchange membranes;
(d) at least one sensor configured and positioned to measure at least one of total dissolved solids content, and sodium, magnesium, and calcium ion concentration of the product water exiting the separation apparatus; and
(e) at least one controller, communicatively coupled to the at least one sensor, the voltage source, and the valves, the at least one controller configured to:
(i) flow the produced water and the second water through the product and concentrate chambers, respectively;
(ii) apply an electric potential across the cation and anion exchange membranes as the produced and second waters flow through the product and concentrate chambers, respectively; and
(iii) produce, by desalinating the produced water, product water having a total dissolved solids content of between 300 mg/L and 8,000 mg/L, a total concentration of calcium ions and magnesium ions less than 100 mg/L, and a sodium adsorption ratio of 20 to 90.

16. The system of claim 12, further comprising a pretreatment unit positioned upstream of the separation apparatus and configured to pretreat the produced water to reduce a concentration of any one or more of suspended solids, greases, and oils therein prior to desalination using the separation apparatus, wherein the pretreatment unit is configured such that the total dissolved solids content of the produced water before pretreatment and the total dissolved solids content of the produced water after pretreatment are within 20% of each other.

17. The system of claim 12, wherein the electrically-driven membrane separation apparatus comprises at least one of an electrodialysis apparatus, an electrodialysis reversal apparatus, and an electrodeionization apparatus.

18. The system of claim 12, wherein at least one of the anion exchange membranes of the electrically-driven membrane separation apparatus has permeability of at least 1.5 toward multivalent sulfate ions over monovalent chloride ions.

19. The system of claim 12, wherein at least one of the anion and cation exchange membranes comprises crosslinked copolymers that comprise at least 20 wt % crosslinking monomers of total monomers for the crosslinked copolymers.

20. The system of claim 16, wherein the crosslinked copolymers comprise acrylic-base crosslinked copolymers, wherein monomers for the acrylic-base crosslinked copolymers comprise at least one of acrylate-base monomers, methacrylate-based monomers, acrylamide-based monomers, and methacrylamide-based monomers.

21. The system of claim 12, further comprising a pH control and acid dosing apparatus configured and positioned to dose the second water with an acid such that a pH of the second water is between 3 and 8.

22. The system of claim 12, wherein the at least one controller is further configured to:
(a) reverse a polarity of the electric potential from an initial polarity to a reverse polarity; and then
(b) reverse the polarity of the electric potential from the reverse polarity to the initial polarity,
wherein the chambers through which the produced and second waters flow remain unchanged immediately before, during, and immediately after the polarity is reversed.

23. The system of claim 12, wherein the sodium adsorption ratio is determined as
$$\frac{[ Na ]}{\sqrt{[ Ca ] + [ Mg ]}} ,$$
wherein [Na], [Ca], [Mg] are the concentrations in mol/m³ for Na⁺, Ca²⁺ and Mg²⁺ respectively in the product water.

24.-28. (canceled)
